(19) United States
(12) Patent Application Publication
(10) Pub. No.: US 2026/0111611 A1
(43) Pub. Date: Apr. 23, 2026

(54) CONNECTED TERMINAL COMPRISING MEANS FOR EMBEDDING A SECURE IMAGE IN A NON-SECURE IMAGE

(71) Applicant: LEDGER, Paris (FR)

(72) Inventors: Patrice Emmanuel Denis HAMEAU, Bourg-la-Reine (FR); Christian KALUZA, Tullins (FR); Kevin MEUDIC, Asnieres sur Seine (FR); Bruno CHARRAT, Aix en Provence (FR)

(21) Appl. No.: 19/116,978

(22) PCT Filed: Sep. 25, 2023
(86) PCT No.: PCT/FR2023/051473

§ 371 Date: Mar. 28, 2025

(30) Foreign Application Priority Data
Sep. 30, 2022 (FR) FR2209984
Sep. 30, 2022 (FR) FR2209987
Nov. 29, 2022 (FR) FR2212475
May 17, 2023 (FR) FR2304933

(51) Int. Cl. G06F 21/71; G06F 21/85

(52) U.S. Cl. CPC G06F 21/71; G06F 21/85

(57) ABSTRACT

A method for conducting a secure operation using a connected terminal (SPH6) comprising an application processor (APROC), a secure element (eSE) configured to perform the operation using a private key, and a display (DISP) receiving from the application processor non-secure images related to the progress of the secure operation. The method comprises a step of embedding, in at least one non-secure image provided by the application processor and presented on the display, a secure image provided by the secure element and inaccessible to the application processor, the secure image comprising information about the secure operation and extending in at least one determined region (10) of the display.

### CROSS-REFERENCE TO RELATED APPLICATIONS

This application is a 371 National Stage of International Application No. PCT/FR2023/051473, filed Sep. 25, 2023, which claims priority to French Patent Application No. FR2209987, filed Sep. 30, 2022, French Patent Application No. FR2209984, filed Sep. 30, 2022, French Patent Application No. FR2212475, filed Nov. 29, 2022, and French Patent Application No. FR2304933, filed May 17, 2023, the disclosures of which are herein incorporated by reference in their entirety.

### TECHNICAL FIELD

The present disclosure relates to the integration of a secure function in a connected terminal such as a smartphone, and particularly the integration of a hardware wallet function for cryptoassets. The present disclosure also relates to the control of information presented to a user on a terminal screen during the execution of a secure operation.

### BACKGROUND

In recent years, the development of cryptocurrencies or other types of cryptoassets managed by the blockchain, such as non-fungible tokens (NFTs) and Smart Contracts, has given rise to various ways of storing and holding the private keys attached to these different types of cryptoassets. This is how the notions of “wallet”, “cold storage” and “hot storage” of private keys appeared. A “wallet” is a device or program whose function is to manage cryptoassets, and therefore to store the private keys attached to them. So-called “hot wallets” are connected to the Internet and are exposed to hacker attacks or to viruses and malware. These can be wallets managed by centralized exchanges, which do not offer the highest level of security. “Hot” wallets can also take the form of programs installed on mobile phones, tablets or personal computers (“software wallets”). Such wallets are permanently connected to the internet and integrate many unsecured applications, and are therefore themselves exposed to attacks.

Cold wallets are the most secure solution for cold storage of private keys, i.e. removed from direct access to the internet, which reduces the attack exposure and thus the risk of theft by hacking. Transactions involving private keys are signed in an offline environment. Any transaction initiated online is temporarily transferred to the offline hardware wallet, where it is then digitally signed before being transmitted to the online network. Since the private key is not communicated to the online server during the signing process, a hacker cannot access it.

Hardware wallets are a convenient alternative to passive wallets for storing private keys. In addition, they are usually configured to generate recovery phrases to restore private keys if they are lost. Note that cryptoassets are never stored in a hardware wallet but are recorded on the blockchain. The hardware wallet only stores the private keys to manage transactions on the blockchain. The public keys corresponding to private keys point to an address on the blockchain where the assets are effectively located.

As shown in FIG. 1, a hardware wallet HW is never directly connected to the internet. To be usable, the hardware wallet HW must be connected to a host device HDV via a data link LNK, e.g. USB or Bluetooth. The host device HDV may be a computer, a mobile phone or a tablet, and runs so-called “companion” software for conducting transactions on the blockchain BCN, such as the “Ledger Live” software developed by the applicant. Alternatively, the hardware wallet HW may be used, through the HDV host device, with decentralized exchanges or DEXs, where the user can transact while keeping their keys in the hardware wallet.

The hardware wallets marketed by the applicant have been commercially successful because of the high degree of security they offer, through the use of a “secure element” to store private keys and sign transactions. A secure element is a hardware platform that can store and manipulate data in compliance with the security rules and requirements set by a trusted authority. It comes in the form of a semiconductor chip that implements various countermeasures against fraudster attacks.

FIG. 2 shows the architecture of a hardware wallet HW1 marketed by the applicant as the “Nano S”. The hardware wallet HW1 features a secure element SE1 paired with a microcontroller MCU1. The microcontroller MCU1 has a USB interface U1 and acts as a proxy device for the secure element SE1, for communication with an external host device HDV running a companion application (see FIG. 1). The secure element SE1 has its own Secure Operating System OS (firmware) that allows it to run application programs APP, and incorporates a cryptographic coprocessor CRY. The hardware wallet HW1 also features a display DISP1 and two buttons B1, B2, managed by the microcontroller MCU1. The user must press both buttons at the same time to demonstrate their agreement or consent for performing or completing the operations.

Hardware wallets of the type just described lack Internet connectivity and must be coupled with a host device such as a mobile terminal or smartphone when performing a transaction. They offer a high degree of security because they are mostly inaccessible via public networks and thus have limited exposure to attacks. However, this characteristic makes them less ergonomic and susceptible to being misplaced or forgotten.

Thus, so-called “blockchain” smartphones have been proposed which, while offering the usual functionalities of a mobile phone, integrate a hardware wallet functionality for cryptocurrencies, such as Samsung's® Galaxy S10 model, HTC's® Exodus 1 model, or Sirin Labs'® Finney model. Such smartphones are commonly referred to as “blockchain smartphones” or “crypto-smartphones.” Like hardware wallets, such smartphones are equipped with an embedded secure element and an internal storage space inaccessible by the Internet, allowing for the creation of a cryptocurrency wallet. In other implementations, the main processor has a secure enclave or Trusted Execution Environment (TEE) in place of the secure element.

Despite these precautions, implementing a hardware wallet inside a smartphone inevitably increases the wallet's exposure to Internet attacks and does not offer the same security advantages as a true cold wallet. Furthermore, it is not possible for the user to know with certainty whether displayed data is reliable, as it could be provided by malicious software.

In terms of cryptocurrency, a very high degree of security is required. The blockchain smartphones offer a certain degree of security through the use of a secure enclave or trusted execution environment TEE, but the digital hardware wallet function, which is not the primary function of such a phone, requires more. Indeed, implementing a hardware wallet inside a smartphone partially removes the security advantages of a detached hardware wallet that is only connected when needed. This inevitably increases the wallet's exposure to Internet attacks.

There is therefore a need to provide a portable electronic device connected to the Internet allowing the execution of a transaction on the blockchain and, in particular, capable of executing an application designed to perform transactions on the blockchain, such as the Ledger Live application or equivalent, while offering a high degree of security regarding the preservation of secret keys of crypto asset accounts used for signing transactions.

Document WO2015124088A1 describes a mobile terminal comprising a secure transaction system equipped with a secure display unit and a physical confirmation button, so that when the mobile terminal displays sensitive information in the electronic transaction process, the sensitive information is displayed separately on the secure display unit. A separate physical confirmation button is used as a secure element unit, so that key transaction data can be achieved via the secure element and its secure display unit and its physical confirmation button without going through the general operating system in the mobile terminal.

Document WO2015180581 teaches display sharing between a main chip and a security chip using a switching module controlled by a button (FIG. 3). The switching module receives display data and applies them to a display driver that controls a display screen. In such a mixed architecture where multiple processors share access to a display screen, the display driver arranged at the output of the switching module is susceptible to attacks aimed at controlling the display. Moreover, in practice each processor must be able to address control signals to the display driver, requiring the provision of hardware connections such as conductive tracks. Such hardware connections increase the attack surface (also called exposure surface) of the mixed architecture and particularly the attack surface of the security chip.

Document EP 2 836 968 B1 describes a transaction device comprising a display, an unsecured processor, a secure processor including an image processor, and a mixer interposed between the display on one side and the unsecured processor and the image processor of the secure processor on the other side. The mixer is controlled by the secure processor and allows, in a secure operating mode of the device, the selection of images provided by the secure processor to ensure that the operating system of the unsecured processor no longer has control of the display.

The document “Trusted display and input using screen overlays” of Dec. 4, 2017, BRANDON ANTHONY ET AL: 2017 International Conference on Reconfigurable Computing and FPGAS (RECONFIG), IEEE, pages 1-6, DOI: 10.1109/RECONFIG.2017.8279826, describes a device comprising a display, an unsecured processor, a secure processor, and an FPGA circuit interposed between the display on one side and the unsecured processor and the secure processor on the other side. The FPGA circuit is controlled by the secure processor and allows, in a secure operating mode of the device, the selection of images provided by the secure processor to ensure that the unsecured processor no longer has control of the display.

Document US 2011/0199308 A1 describes a device comprising a non-secure processor, a secure processor, a multiplexer controlled by the secure processor so as to display, in a non-secure mode, or “pass-through” mode, images provided by the non-secure processor, and, in a secure mode, display images provided by the non-secure processor but having been previously stored in a memory and verified by the secure processor, or images locally generated by the secure processor.

There is therefore also a need to improve the security of mixed architectures in which multiple processors share access to a display screen.

There is also a need to integrate a hardware wallet into a conventional mobile terminal platform to transform it into a mobile terminal with an embedded hardware wallet, with minimal modifications to the mobile terminal platform.

### SUMMARY

Embodiments relate to a connected terminal configured to execute a secure operation, the terminal comprising an application processor configured to initiate the secure operation, a secure element for executing the secure operation, and a display accessible via a wired bus and receiving from the application processor image data to be displayed to a user, the terminal comprising means controlled by the secure element and configured to, at the request of the secure element and at least during the execution of the secure operation, alternately apply to the wired bus of the display image data provided by the application processor and image data provided by the secure element, such that the image data provided by the secure element replace image data provided by the application processor and form a secure image embedded in a non-secure image provided by the application processor, the secure image extending in at least one determined region of the display.

According to an embodiment, the terminal comprises at least one light indicator activated by the secure element when the secure element embeds a secure image in a non-secure image provided by the application processor.

According to an embodiment, the terminal comprises means for indicating to the user the location and extent of the region in which the embedded secure image is displayed.

According to an embodiment, the means for indicating the location and extent of the region in which the embedded secure image is displayed comprise a row of light indicators controlled by the secure element and arranged along the edge of the display.

According to an embodiment, the means for indicating the location of the region in which the embedded secure image is displayed comprise a region of the display that is permanently under the control of the secure element, and that displays a determined appearance, and a border of the region in which the embedded secure image is displayed, which has the same appearance as the region of the display that is permanently under the control of the secure element.

According to an embodiment, the means configured to alternately apply to the wired bus of the display image data provided by the application processor and image data provided by the secure element, comprise a multiplexer receiving on a first input the image data provided by the application processor and on a second input the image data provided by the secure element, a control circuit of the multiplexer, configured to control the multiplexer according to a configuration data provided by the secure element.

According to an embodiment, the control circuit is configured to control the multiplexer with a determined embedding granularity of the image data provided by the secure element, said embedding granularity being at the scale of a line or at the scale of a pixel of the image data provided by the application processor.

According to an embodiment, the secure element is configured to, before performing the operation, embed in a non-secure image provided by the application processor a secure image comprising information about the secure operation.

According to an embodiment, the terminal further comprises an input device providing touch data on a data bus, and a demultiplexer controlled by the secure element and configured to connect the data bus of the input device to a bus of the application processor or to a bus of the secure element.

According to an embodiment, the secure element is configured to connect to the input device during the display of information about the operation in the secure image.

According to an embodiment, the terminal comprises a physical button actionable by the user and monitored by the secure element, wherein the secure element is configured to bypass the operation in the absence of a user action on the physical button.

According to an embodiment, the secure element and the means for alternately applying to the wired bus of the display image data provided by the application processor and image data provided by the secure element, are integrated wholly or partially in a system-in-package or in a system-on-chip mounted on an interconnection support of the terminal.

According to an embodiment, the secret operation comprises a step of signing a data using a secret key.

According to an embodiment, the terminal is devoid of a display controller between the display and the means controlled by the secure element, the image data alternately applied to the wired bus of the display by the means controlled by the secure element being in a format compatible with the display and not requiring, to be displayed, to be converted into another format.

Embodiments also relate to a method for conducting a secure operation using a connected terminal, in particular the signing of data using a secret key, the terminal comprising an application processor configured to initiate the secure operation, a secure element holding a private key and configured to execute the secure operation, and a display accessible via a wired bus and receiving from the application processor non-secure images related to the progress of the secure operation, the method comprising a step of embedding, in at least one non-secure image provided by the application processor and presented on the display, a secure image provided by the secure element and inaccessible to the application processor, the secure image comprising information about the operation and extending in at least one determined region of the display, the embedding step being under the control of the secure element and unable to be prevented or corrupted by the application processor.

According to an embodiment, the method comprises the step of providing in the terminal means controlled by the secure element and configured to, at the request of the secure element, alternately apply to the wired bus of the display image data provided by the application processor and image data provided by the secure element, such that the image data provided by the secure element replace image data provided by the application processor and form said secure image embedded in the non-secure image provided by the application processor.

According to an embodiment, image data in a format compatible with the display and not requiring, to be displayed, to be converted into another format are alternately applied to the wired bus of the display, and no display controller is provided between the display and the means controlled by the secure element.

According to an embodiment, the method comprises providing in the terminal at least one light indicator, and comprising a step of activating the light indicator by the secure element when the secure element embeds a secure image in a non-secure image provided by the application processor.

According to an embodiment, the method comprises a step of indicating to the user the location and extent of the region in which the embedded secure image is displayed.

According to an embodiment, the location and extent of the region in which the embedded secure image is displayed are indicated by means of a row of light indicators controlled by the secure element and arranged along the edge of the display.

According to an embodiment, the location and extent of the region in which the embedded secure image is displayed are indicated by means of a region of the display that is permanently under the control of the secure element and that has a determined appearance, and a border of the region in which the embedded secure image is displayed, which has the same appearance as the region of the display permanently under the control of the secure element.

According to an embodiment, the device comprises an input device providing touch data on a data bus, and the method comprises the step of connecting the input device to the secure element during the display of information about the secure operation in the embedded secure image.

According to an embodiment, the device comprises a physical button actionable by the user and monitored by the secure element, and the method comprises a step of configuring the secure element such that it bypasses execution the secure operation in the absence of a user action on the physical button.

### BRIEF DESCRIPTION OF THE DRAWINGS

Examples of architectures for connected terminals including a cryptocurrency hardware wallet will be described in the following in a non-limiting manner in relation to the attached figures among which:

FIG. 1 illustrates conventional use examples of a hardware wallet through a host device,

FIG. 2 shows a conventional architecture of a cold hardware wallet,

FIG. 3 shows a first embodiment of a connected terminal embedding a hardware wallet,

FIG. 4 shows a second embodiment of a connected terminal embedding a hardware wallet,

FIG. 5 shows a third embodiment of a connected terminal embedding a hardware wallet,

FIG. 6 shows a fourth embodiment of a connected terminal embedding a hardware wallet,

FIG. 7 shows a fifth embodiment of a connected terminal embedding a hardware wallet,

FIG. 8 shows a sixth embodiment of a connected terminal embedding a hardware wallet and comprising a dynamic multiplexer for embedding a secure image in a non-secure image,

FIGS. 9A, 9B, 9C, 9D and 9E show various embodiments of a method for embedding a secure image in a non-secure image,

FIG. 10 shows a first embodiment of the dynamic multiplexer,

FIG. 11 shows a second embodiment of the dynamic multiplexer,

FIG. 12 shows a third embodiment of the dynamic multiplexer,

FIG. 13 shows a fourth embodiment of the dynamic multiplexer,

FIG. 14 shows a fifth embodiment of the dynamic multiplexer,

FIG. 15 shows a sixth embodiment of the dynamic multiplexer, and

FIG. 16 shows an arrangement of components of a connected mobile terminal according to one of the embodiments of FIGS. 4 to 8, 10 to 14.

### DETAILED DESCRIPTION

The following will describe architectures of a connected terminal including an embedded hardware wallet designed to avoid or limit attacks made possible by such a configuration. To avoid creating an entirely new ecosystem and not harm the user experience, compatibility with existing hardware and operating systems (Android, iOS) is sought, as well as using traditional application distribution channels. Thus, it is assumed that the connected terminal considered is able to install and execute applications that may come from unknown, or even dubious sources, which increases the challenge of securing transactions with the embedded hardware wallet. It is also assumed that installable applications can gain access to hardware resources involved in communication with a secure element implementing the hardware wallet.

For example, malicious software could record pressed keys to steal a secret code, simulate pressed keys to falsify a transaction, modify the display to deceive the user about the transaction they are executing, etc.

More specifically, the validation of a transaction on a phone by a virtual keyboard can be intercepted by a low-level spyware having access to the touchscreen interface by detecting the coordinates of touches on the touchscreen. Without knowing what is displayed, the spyware may rely on the assumption that the displayed virtual keyboard is one of the many traditional keyboards available on the platform, so that the touch coordinates reveal the keyboard keys. The spyware may also have access to accelerometers or other sensors typically present in a mobile terminal—touches at different positions on the screen translate into different acceleration values in rotation on two axes, so that touch positions can be deduced.

To partially remedy this, conventional applications display, for personal identification code entry, a numeric virtual keyboard with randomly positioned keys. However, although this measure is useful for hindering the deduction of an identification code, malicious software could deduce that a transaction is in progress and, before the user has finished, modify the amount or recipient and simulate validation of the transaction by modifying the application's inputs without modifying the application itself.

FIG. 3 represents an embodiment SPH1 of a mobile terminal or other connected device embedding a hardware wallet. The mobile terminal comprises an application processor APROC connected to various peripheral devices, particularly a touchscreen including a display DISP and a touchpad KBD. The application processor is for example a baseband processor providing telephone communications and including Internet connectivity. The processor manages the display through a bus DISPB implementing a determined video interface protocol, for example the MIPI DSI protocol (“Display Serial Interface”). The MIPI-DSI protocol has been widely adopted by the industry and is currently ubiquitous in smartphones. It is also widely used in tablets, laptops, and laptop/tablet hybrids. The processor manages the touchpad KBD through another interface, for example a data bus DB1 of I2C type. For readability of the drawing, not all elements of a mobile terminal are represented.

The application processor APROC also integrates a secure enclave or trusted execution environment TEE. Such an enclave generally includes a dedicated processor, memory, and touchscreen manager (also called display controller). It is designed to implement a trusted user interface TUI, for example as recommended by the “Trusted User Interface API” document from GlobalPlatform® available at the following address:
https://globalplatform.org/wp-content/uploads/2013/06/GlobalPlatform_Trusted_User_Interface_API_v1.0.pdf

Thus, this enclave can, according to instructions executed by the application, manage the display DISP and user input on the touchpad KBD, as shown.

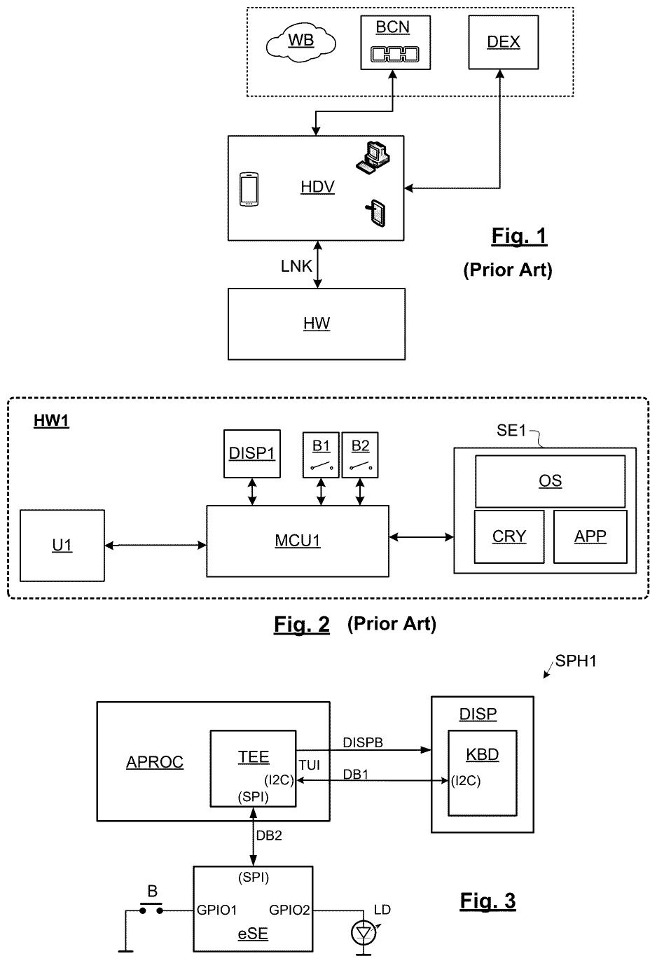

The mobile terminal also includes an embedded secure element eSE implementing a cryptocurrency hardware wallet. The element eSE may be similar to that integrated in the detached hardware wallets described previously. It may be the ST33 secure microcontroller from STMicroelectronics® which has, among other things, a secure Serial Peripheral Interface (SPI), two Inter-Integrated Circuit interfaces I2C and various programmable input/output pins GPIO. The link designated by LNK in FIG. 1 between the mobile terminal HDV and the detached hardware wallet HW, for example a USB or Bluetooth interface, is here implemented by a permanent wired connection between the secure element eSE and the application processor, here a data bus DB2. The bus DB2 is for example an SPI bus connected to the eponymous interface of the ST33 microcontroller. To ensure better communication security, the other end of bus DB2 may be connected to the TEE enclave.

The implementation of the hardware wallet function in the element eSE and the exchanges between the element eSE and the application processor may be entirely similar to what is known from FIGS. 1 and 2 and will not be described in more detail.

Furthermore, one of the input/output pins GPIO1 of the secure element eSE is connected to a physical button B provided to validate transactions through a mechanical operation. The pin GPIO1 is exclusively managed by the secure element and its state change is impossible to simulate by software executed on the application processor. Another input/output pin GPIO2 of the secure element eSE controls a light indicator LD formed here by an LED diode to signal that a secure operation is in progress with the hardware wallet in the element eSE. Button B is a dedicated physical button arranged, for example, on a lateral wall of the mobile terminal, which is visually distinct from other buttons typically provided on the mobile terminal. The light indicator LD is also dedicated and conspicuous compared to other light indicators typically provided on the mobile terminal.

With this configuration, a transaction is prepared in the usual way by an official application, such as “Ledger Live”, executed by the application processor. From the moment when the user must validate the transaction, the application passes through the enclave TEE to display the transaction on the display DISP and, if applicable, manage a user input phase on the touchpad KBD, such as entering an identification code to unlock the secure element. The validation and signing of the transaction are delegated to the element eSE (the hardware wallet) by commands issued on the bus DB2 through the enclave TEE. If applicable, the inputted unlock code is transmitted to the secure element via the bus DB2. The element eSE responds to these commands by activating the light indicator LD and waiting for a press on button B.

When the user presses button B, the element eSE calculates the transaction signature with the private keys stored in the wallet and transmits the signature to the application via the bus DB2. The secure element, having completed its task, deactivates the light indicator LD and waits for new commands. The application updates the blockchain through a network service, displays useful information, and waits for new user interaction.

If no action is detected on button B after a timeout, the transaction is canceled. The secure element signals this to the application via the bus DB2, deactivates the light indicator LD, and waits for new commands.

Button B has a similar function to the buttons B1, B2 of a detached hardware wallet of the type of FIG. 2. Malicious software, if it manages to modify the amount or address of the transaction, will not be able to simulate a validation, which requires the actuation of a physical button detectable only by the element eSE. Thus, the user, before validating, can confirm that the transaction as displayed is indeed the one they initiated. If the transaction has been modified, the user can in principle notice it on the display and cancel the transaction. The cancellation may be performed conventionally by pressing a virtual button on the touchscreen. The cancel button function cannot be hijacked into a validation function, since validation is only possible using button B managed exclusively by the element eSE.

The light indicator LD is activated and confirms to the user that the secure element is handling the operations and that the requests made to it by the terminal are from a trusted source.

According to a variant slightly more costly in terms of manufacturing the mobile terminal housing, two physical buttons could be provided that must be pressed simultaneously to validate a transaction.

Despite the control of the display by the enclave TEE, sophisticated malicious software could modify the input and/or output data of the application to hijack them and particularly modify the display of information related to the transaction to be verified by the user. For example, the software could intercept transaction data entered by the application to replace them with fraudulent data, such as the transaction amount and address. Even if this is difficult when input is performed in secure mode via the enclave TEE, such an attack is not impossible given the degree of security offered by a TEE enclave. The application then generates a transaction with modified data for the element eSE and a corresponding erroneous display. The display, which then betrays the modification, can also be intercepted and modified, so that it corresponds to the transaction initially desired by the user. Thus, the user will see apparently correct transaction data on the display and validate the transaction, but this validation will apply to the fraudulently modified transaction that has been stealthily delegated to the element eSE.

In a conventional detached hardware wallet, this type of fraud is thwarted by the fact that the hardware wallet reproduces on its own display the transaction it will execute: the user relies on the transaction displayed by the detached wallet, and can compare it to that displayed by the application on the terminal. Such functionality is not feasible when the hardware wallet is embedded in a smartphone, given the difficulty of providing a second display and the additional cost this would entail.

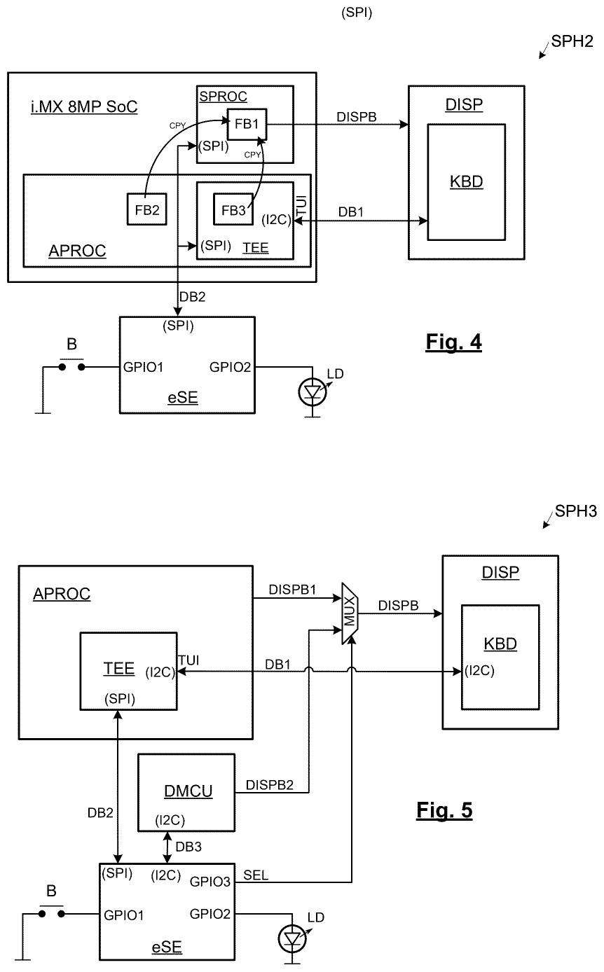

FIG. 4 shows an embodiment SPH2 of a mobile terminal integrating a hardware wallet and defeating this type of display manipulation. The application processor APROC including the enclave TEE is here integrated into a system-on-chip SoC receiving a secondary processor SPROC. The SoC may be the i.MX 8M Plus circuit from NXP®. The element eSE is, as previously, connected to the enclave TEE by the bus DB2, for example an SPI bus. The processor SPROC has its own display controller and can be considered as having a high degree of security because it is partitioned from other circuits of the SoC, similar to a secure element. Thus, like the secure element, processor SPROC can receive commands from the enclave TEE via the bus DB2. The display controller of processor SPROC is the sole master of the bus DISPB and includes a frame buffer FB1 that processor SPROC can fill from a frame buffer FB2 of the application processor or a frame buffer FB3 of the enclave TEE (arrows CPY), or even from display data generated by itself, as needed. In another embodiment, processor SPROC can directly display data from memory FB2 or FB3 using a pointer that has been provided to it. Such display mechanisms are documented and will not be described in more detail. Thus, according to the needs of a running application, display DISP receives its data from the application processor, the enclave TEE, or processor SPROC itself.

With this configuration, a transaction is prepared in the usual way by an official application, such as “Ledger Live”, executed by the application processor APROC. The touchpad KBD is still managed by the enclave TEE to secure user input of data involved during a transaction, for example an unlock code or an accepted transaction amount, and delegates the transaction processing to the secure element via the bus DB2. In order to overcome potential recognized flaws of a display managed by the enclave TEE, the secure element eSE, which is itself connected to processor SPROC via the bus DB2, is configured to provide to the latter the transaction data to be validated by the user.

The secure element eSE is configured to, after receiving the transaction data it must validate by signing the transaction using a private key, transmit to processor SPROC via the bus DB2 the corresponding display data, and request processor SPROC to display them via the display controller FB1, instead of the data that might be present in frame buffers FB2 and FB3.

Thus, even if the official application is configured to generate such data and transmit them to the display controller of the enclave TEE to fill the frame buffer FB3, or transmit them to the display controller of the application processor to fill the frame buffer FB2, these data will not be displayed and will be replaced by data provided by the secure element. Consequently, if compromised data produced by the application are in frame buffer FB2 or FB3, these data will be ignored and it is the data produced by the secure element in frame buffer FB1 that will actually be displayed.

This embodiment SPH2 relies on the use of a particular system-on-chip that might not suit certain smartphone manufacturers. Additionally, it is susceptible to a type of attack that would make the secure element believe it is communicating with processor SPROC when it is actually communicating with a hacked TEE enclave. The secure element therefore does not have absolute certainty of having access to the display when it believes it has access.

Embodiments are set out in the following that can be implemented with more conventional components, while offering a high level of security regarding the control of data displayed to the user.

FIG. 5 shows an embodiment SPH3 of a mobile terminal that is derived from the embodiment SPH1 of FIG. 3 and includes, as previously, the application processor APROC and the enclave TEE, the display DISP, the touchpad KBD, the secure element eSE, the physical button B connected to pin GPIO1 to validate transactions, and the light indicator LD controlled by pin GPIO2, to signal that a secure operation is in progress in the element eSE. As previously, the touchpad KBD is controlled by the enclave TEE via the bus DB1, for example an I2C bus. The enclave TEE is connected to the secure element eSE by the bus DB2, for example an SPI bus.

Terminal SPH3 differs mainly from terminal SPH1 in that it includes a display controller DMCU exclusively serving the secure element eSE, and a multiplexer MUX whose output is connected to the bus DISPB of the display DISP. This multiplexer receives on a first input, via a bus DISPB1, the display data produced by the application processor APROC. These display data no longer need to be managed by the enclave TEE, as shown, but can be if desired. A second input of the multiplexer receives, via a bus DISPB2, display data generated by the display controller DMCU. An input/output pin GPIO3 of the secure element eSE provides a selection signal SEL for the multiplexer input that will be connected to the output of the latter. Thus, depending on the value on signal SEL, multiplexer MUX connects the bus DISPB of the display to either the bus DISPB1 of the application processor APROC or the bus DISPB2 of the display controller DMCU. In a variant, the signal SEL can also be taken from pin GPIO2 that controls the light indicator LD.

The display controller DMCU receives display commands from the secure element eSE via a bus DB3, for example an I2C bus. The I2C protocol offers relatively low data throughput, but is used here to carry only textual and vector display commands, using low bandwidth. The secure element eSE is thus programmed to generate basic display commands for the transactions it processes and transmit them to the display controller DMCU.

The display controller DMCU is here a separate circuit, since secure elements commonly available on the market are not equipped with a graphics processor and do not have sufficient bandwidth to generate the bitmap images expected on the bus of a display such as that of a modern smartphone. The display controller DMCU is for example a STM32 microcontroller from STMicroelectronics® including an LCD-TFT display controller fitted with a MIPI-DSI interface.

The secure element eSE is configured to command multiplexer MUX so that it by default applies to display DISP the display data from the application processor APROC. When an application requests the secure element eSE to sign a transaction, the latter sends display commands of the transaction data to the display controller DMCU and switches multiplexer MUX so that the graphic data produced by controller DMCU reach display DISP. The light indicator LD is activated and the secure element eSE awaits user validation by monitoring the state of button B.

Thus, display DISP presents to the user transaction data actually received and processed by the secure element eSE. If these data have been modified by a malicious program, the user will not fail to notice it and may cancel the transaction.

It is also preferable that the capture of information entered by the user on the touchpad KBD, for example an unlock code or other sensitive information such as a target transaction amount, present a degree of security that is at least of the same level as that of the display. In the embodiments SPH1, SPH2, SPH3 just described, this capture is performed by the enclave TEE and therefore offers a lower degree of security than that of the display. A higher level of security might therefore be desired.

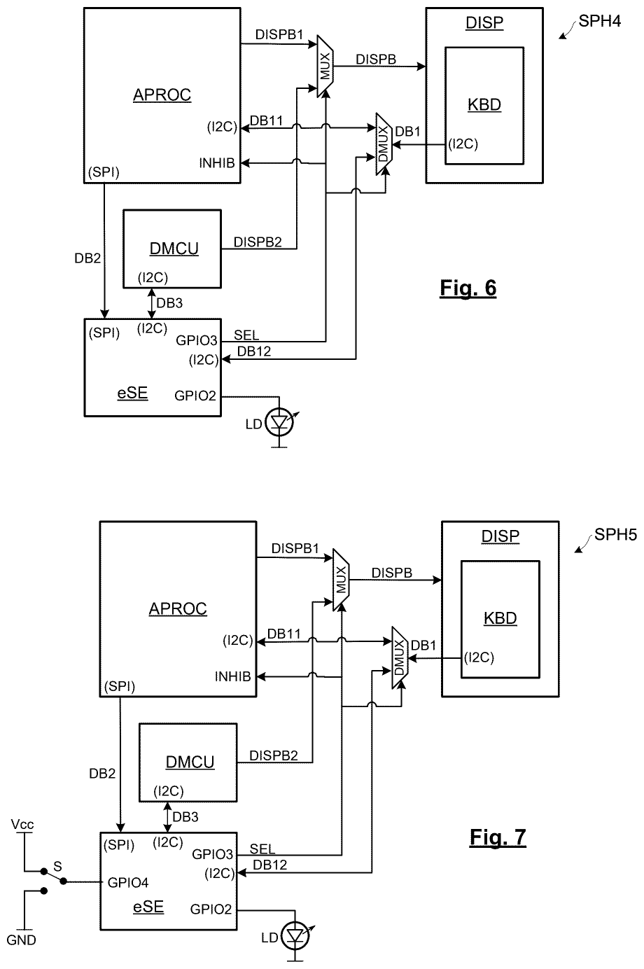

FIG. 6 is a block diagram of an embodiment SPH4 of a mobile terminal that differs from that SPH3 of FIG. 5 in that the output bus DB1 from the touchpad KBD, here of I2C type, is connected to the input of a demultiplexer DMUX with two outputs. A first output of the demultiplexer DMUX is connected to the application processor APROC via a bus DB11, and a second output of the demultiplexer is connected to the secure element eSE via a bus DB12. The selection of the demultiplexer DMUX can be operated by the same signal SEL as that applied to the multiplexer MUX by the secure element. The two buses DB11 are preferably of the same type as the bus DB1 to avoid providing a protocol converter in the demultiplexer DMUX.

In this embodiment, no enclave TEE is provided to execute all or part of the applications involving the secure element, which are therefore executed by the application processor APROC except for the steps delegated to the secure element. However, nothing prevents providing a TEE enclave and using it to control the buses DISPB1 and reception of touch data DB11 during the execution of non-sensitive phases of the application.

The secure element eSE is configured to position by default the multiplexer MUX and the demultiplexer DMUX so that they connect the display DISP and the touchpad KBD to the application processor, particularly during a preparatory phase of a transaction. The secure element then modifies the value of the signal SEL during sensitive phases of transaction execution, in order to itself receive any information provided by the user via the touchpad KBD, and in order to itself provide, through the display controller DMCU, the transaction data to be presented to the user.

Thus, the touchpad escapes the control of the application during its connection to the secure element, and the application can no longer implement the input phase. The input phase is delegated to the secure element, which is here configured to manage a virtual keyboard for both input and display.

In an embodiment, the bus DB12 is connected to input/output pins of the display controller DMCU, instead of being connected to the secure element. This embodiment can be advantageous if the display controller is a microcontroller of the type proposed above, having a data processing capacity superior to that of the secure element. Since the display controller DMCU is under the control of the secure element, it can then receive and process for the secure element a large amount of data that the latter might not be able to process, for example data from a touch keyboard, and communicate the result of this processing to it via the bus DB3.

When a transaction is delegated by the application to the secure element via the bus DB2, this time without passing through the enclave TEE, the secure element eSE controls the multiplexer and the demultiplexer to connect the display DISP to the display controller DMCU and to connect the touchpad KBD to the secure element eSE. The secure element eSE implements the input phase, if input is required. Input on the touchpad can no longer be intercepted or modified by software running on the application processor, while any attempt to modify the display by software running on the application processor is ignored.

Given this configuration, software running on the application processor cannot simulate false validations on the touchpad, so the physical button B is optional: validation can be done securely using the touchpad.

The securing of the touchpad KBD that has just been described as an improvement of the embodiment SPH3 of FIG. 5 is also applicable to the embodiment SPH2 of FIG. 4 in which, in secure mode, the bus DB1 of the touchpad will be routed to the secure element instead of being connected to the enclave TEE.

In an embodiment, the signal SEL, or any other indicator of the secure mode (such as the control signal of the light indicator LD), can be used to inhibit circuits that are in principle unused during the secure mode. As shown in FIG. 6, the signal SEL is for example applied to an INHIB pin of the application processor. It may be provided that the switching of the signal SEL to its value corresponding to the secure mode causes the processor to reset by cutting its clock signal or cutting its power supply. In this case, any malicious software running on the application processor performing analyses to deduce cryptographic keys or other sensitive information is rendered inoperative during the secure transaction.

Total inactivation of the application processor is possible, in particular, in the configuration of FIG. 6, where all functions that must remain active during the transaction are moved to the secure element eSE. In cases where the application processor cannot be deactivated, the signal SEL can be used to deactivate auxiliary circuits that could be used to deduce sensitive information, such as accelerometers that allow deducing touchpad touch positions. Accelerometers are generally integrated into a dedicated inertial measurement unit or IMU. Such an inertial measurement unit can be deactivated by stopping its clock, cutting off its power supply, or cutting off its communication link with the application processor, generally an I2C bus.

Malicious software may be designed to initiate transactions when the secure element is in a configuration where it does not request an unlock code, for example during a limited time after performing a previous transaction. The malicious software attempts in this case to modify the display, but this attempt fails because it is the secure element eSE that is the master of the display in the embodiments of FIGS. 5 and 6. Thus, the display reflects the transaction actually initiated by the malicious software, while the secure element eSE awaits user validation on the touchpad (in the configuration of FIG. 6), or on the physical button B (in the configuration of FIG. 4 or 5). In the case of FIG. 3, fraudulent modification of the display is possible, so that the user may be deceived about the nature of the transaction.

If the fraudulent transaction is initiated at a time when the user has the mobile terminal in view, the user sees, without having requested it, the mobile terminal enter secure mode (light indicator LD), display the transaction and request validation. The user can verify the display and cancel the transaction, but this requires the user to be focused and not validate the transaction by mistake.

If the user does not have the mobile terminal in view, the transaction is in principle automatically canceled at the expiration of a timeout period. However, if the mobile terminal is subjected to jolts in a pocket or bag, an unintended validation could occur before the timeout period expires, either by pressing the physical button B (FIGS. 3 to 5), or by pressing the touchpad (FIG. 6) which could be configured to be operational on the mobile terminal's lock screen when requesting validation.

FIG. 7 shows an embodiment SPH5 of a mobile terminal defeating this type of fraud. In addition to the elements of the embodiment of FIG. 6, a physical bistable switch S is connected to an input/output pin GPIO4 of the secure element eSE. In a first position, switch S connects input GPIO4 to a high logic level, for example a supply voltage Vcc, and in a second position, switch S connects input GPIO4 to a low logic level, for example a ground voltage GND. Switch S is arranged, for example, on one of the lateral walls of the mobile terminal.

The secure element eSE is programmed not to process commands received via bus DB3 in one of the positions of switch S, for example the first, and to accept transaction requests received via bus DB3 in the other position. Terminal SPH5 is designed so that switch S is the only means available to switch the secure element's mode, meaning that an application can no longer by itself delegate the processing of a transaction.

Thus, the secure element's mode is exclusively under the control of the user who chooses the mode using switch S according to needs.

Switch S being initially in the inactive mode position, an application likely to initiate transactions is then designed to prompt the user to change modes when it is about to delegate transaction processing to the secure element eSE. It can send to display DISP a message like “Please put the phone in secure mode using the switch”, preferably with information about the ongoing transaction. This message is analogous to a message inviting the user to connect their conventional detached wallet to the mobile terminal.

The user then toggles the switch to enter active mode. The secure element eSE responds by taking various protective measures, such as toggling the signal SEL to connect display DISP and touchpad KBD respectively to the dedicated display controller DMCU and to the secure element eSE. The light indicator LD is also activated to signal to the user that the mobile terminal is in secure mode. The secure element eSE sends an acknowledgment to the application which resumes execution by transmitting the transaction information to the secure element. The secure element eSE operates the user input phase from the touchpad KBD, if applicable, and requests validation from the user by displaying the transaction information again.

When the transaction is validated and signed, the secure element eSE communicates the signed transaction to the application which records it on the blockchain. The secure element prompts the user to change modes, by sending to display DISP a message like “Please exit secure mode by toggling the switch”. This message is analogous to one indicating that the user can remove their conventional detached wallet. When the switch is toggled, the initial connections of the display and touchpad are restored, and the light indicator LD is deactivated.

Switch S can also be implemented in the structures of FIGS. 4 and 5, where the touchpad KBD is not connected to the secure element. In this case, it is the application that operates the input phase before requesting the toggling of switch S.

Of course, switch S, at the user's mercy, could be toggled at times when it is not required, or not toggled when required. Various combinations are thus not “normal”, and this can be signaled to the user through displayed messages or alarms, encouraging the user to toggle the switch so operations can resume normally.

Malicious software could also behave like an official application by requesting a mode change. However, since the user has not initiated the transaction and is being asked for a relatively constraining action, they are likely to be more vigilant. The malicious software can no longer display a misleading off-topic message, since the user expects to see transaction information. Such transaction information will be difficult to make credible, especially if it is true—typically a transfer of a large amount to an unknown address. If the malicious software attempts to hide the nature of the transaction, it will be revealed and different when it is displayed for validation by the secure element eSE, if the user has nevertheless been induced to switch to secure mode.

In any case, a pending transaction, whether fraudulent or not, can no longer be validated by an unintended press on a physical or virtual button, because the user must intentionally switch the mobile terminal to secure mode to validate the transaction.

In the embodiments just described in relation to FIGS. 5 to 7, the secure element takes control of the display DISP when it switches to secure mode, with the application processor APROC or enclave TEE no longer having access to it. However, in certain secure applications, particularly those running on detached hardware wallets, it is provided that the transaction data are displayed simultaneously on the screen of the host device (mobile phone or PC running, for example, the “Ledger Live” software) and on the display of the hardware wallet. Thus, the user can at a glance verify that the transaction data presented by the application are identical to those presented by the hardware wallet and about to be executed by the secure element.

It was noted above that such functionality is not feasible when the hardware wallet is embedded in a smartphone, given the difficulty of providing a second display and the additional cost this would entail. It was thus proposed that the display of transaction data be placed under the control of the secure element.

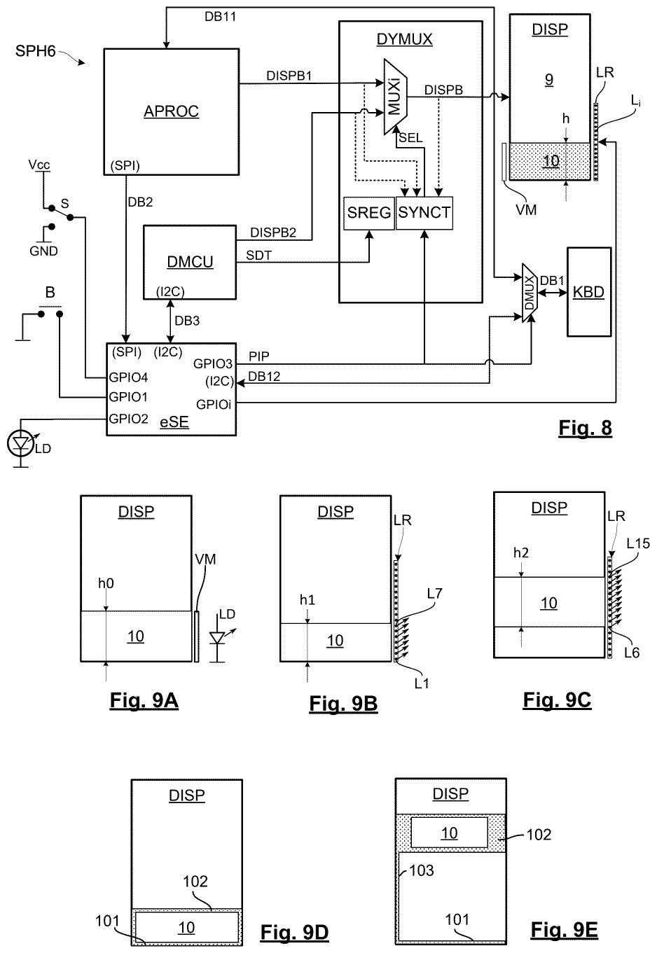

In an embodiment SPH6 of a connected terminal integrating a hardware wallet as shown in FIG. 8, a dynamic multiplexer DYMUX is provided to allow the secure element eSE and the application processor APROC to present information simultaneously on the display, by embedding a secure image provided by the secure element in a non-secure image provided by the application processor. The secure image is embedded in a region 10 of the display DISP. The rest of the available display surface forms a region 9 that receives the part of the non-secure image that is not masked by the embedded secure image. Regions 9 and 10 are preferably such that they together cover the entirety of the available display surface.

Such image embedding significantly improves the security offered by the terminal and its ergonomics when conducting a transaction. For example, the application processor can display in region 9 the following information: “you wish to purchase 2 bitcoins for a value of 50,000 USD” while the secure element displays in region 10 of the display the following information: “please confirm your purchase of 2 bitcoins for a value of 50,000 USD” as well as a representation of a validation button on which the user must perform a touch action to trigger the transaction.

As another example, the application processor can display in region 9 the following information: “please confirm your request to purchase 2 bitcoins for a value of 50,000 USD by confirming on the secure touch keypad the number of bitcoins you want to purchase, then the value of this transaction” while the secure element displays in region 10 a virtual keyboard allowing the user to enter the two transaction details, here the number of bitcoins and the transaction value.

In yet another variant, button B is used to confirm the transaction, the application processor displays in region 9 the following information: “please confirm your request to purchase 2 bitcoins for a value of 50,000 USD by pressing button B” while the secure element displays in region 10 the same information: “please confirm your request to purchase 2 bitcoins for a value of 50,000 USD by pressing button B”. Any difference between the transaction details displayed by the application processor and the secure element will be perceived by the user due to the simultaneity of these displays.

The embodiment SPH6 shown in FIG. 8, allowing such image embedding, differs from that SPH5 shown in FIG. 7 in that the hardware multiplexer MUX previously described is replaced by a dynamic multiplexer DYMUX. The dynamic multiplexer DYMUX includes a hardware multiplexer MUXi which, like the multiplexer MUX of FIG. 7, has a first input connected to the bus DISPB1 of the application processor, a second input connected to the bus DISPB2 of the display controller DMCU of the secure element eSE, and an output connected to the bus DISPB that controls the display. The dynamic multiplexer DYMUX also includes a synchronization circuit SYNCT that provides the signal SEL to the multiplexer MUXi and receives an image overlay authorization signal PIP provided by the pin GPIO3 of the secure element.

The signal PIP has an active value and an inactive value, corresponding in practice to two logical values of this signal, for example 0 and 1 or vice versa. When it is not solicited for a transaction, or when it does not need—or no longer needs—to interface with the user, the secure element sets the signal PIP to the inactive value. In this case, the synchronization circuit SYNCT commands the multiplexer MUXi so that the bus DISPB at its output is permanently connected to the bus DISPB1 of the application processor. The application processor then has full control of the entire display.

When it switches to secure mode to participate in the execution of a transaction, and/or when it needs to interface with a user, the secure element sets the signal PIP to its active value, which triggers the superposition of image data provided by the application processor and image data provided by the secure element through the display controller DMCU, at the rhythm of the changes in the value of the SEL signal provided by the SYNCT circuit.

The image data provided by the application processor APROC are then displayed in region 9 of the display and the image data provided by the display controller DMCU are displayed in region 10. More precisely, the image data provided by the application processor and corresponding to region 10 are replaced—or overwritten—by the image data provided by the secure element, so that the image data displayed in region 9 are those that have not been overwritten by those provided by the display controller DMCU.

To provide the SEL signal, the SYNCT circuit takes into account a configuration data SDT (“Setup Data”) that determines the size, shape, and location of region 10 occupied by the embedded image. The SYNCT circuit also takes into account synchronization information taken from or extracted from the buses DISPB1, DISPB2, and DISPB, so that the transitions on the bus DISPB between the image data provided by the application processor APROC and the image data provided by the display controller DMCU do not cause the appearance of artifacts or image tearing.

In an embodiment, the size of region 10 is fixed and the configuration data SDT is hardcoded in a configuration register SREG of the multiplexer DYMUX. The SDT data includes, for example, the position of the first line and the position of the last line of region 10, which determine the height h of region 10, or, equivalently, the position of the first line and the number of subsequent lines. Alternatively, the data SDT may include only the position of the first line of region 10 if it occupies the entire bottom part of the display. In another embodiment, the configuration register is instead configurable and receives the configuration data SDT from the outside, for example provided by the display controller DMCU at the request of the secure element, or directly provided by the secure element.

The output bus DB1 of the touchpad KBD, here of I2C type, is, as previously, connected to the input of the demultiplexer DMUX whose first output is connected to the application processor APROC by bus DB11 and the second output connected to the secure element eSE by bus DB12.

The selection of the demultiplexer DMUX is operated here by the signal PIP so that during the entire period when the terminal operates in secure mode and where the image parts provided by the secure element replace those provided by the application processor, the secure element has exclusive control of the touchpad. It is therefore not possible—and in practice hardly necessary—that during operation in secure mode, the application processor offers the user touch functionalities in region 9, unless it is provided that these are handled by the secure element which will then relay the touch information to the application processor.

If this may have a practical or ergonomic interest, those skilled in the art may nonetheless provide a more complex embodiment so that the application processor receives in real time the touch data corresponding to region 9 of the display where it can display information. For this purpose, the demultiplexer DMUX could, for example, be controlled by the signal SEL provided by the SYNCT circuit.

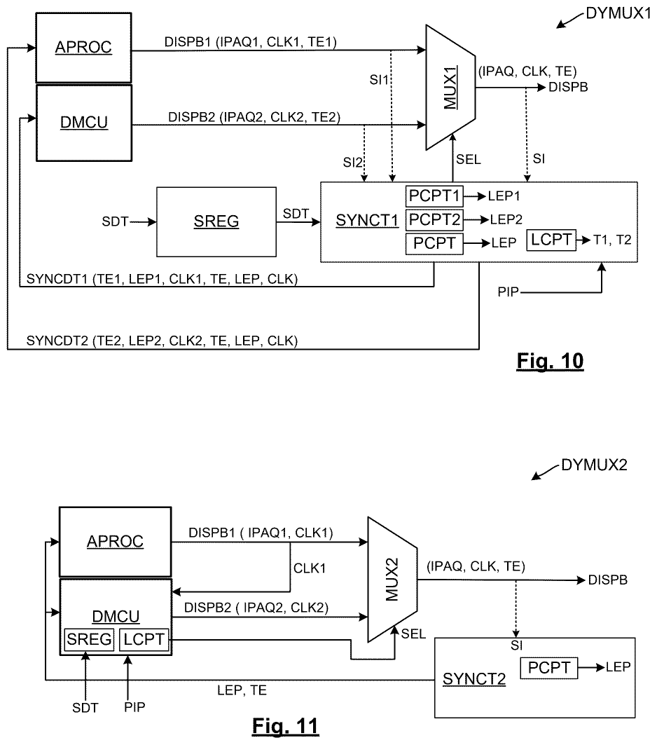

The risk analysis attached to each terminal configuration proposed in the present application reveals here the risk that a malicious program having taken control of the application processor or the bus DISPB1 could display in region 10 information that simulates that displayed by the secure element during the execution of a transaction. Thus, the user, after having themselves requested a transaction, might be tempted to think that this transaction is being executed by the secure element while region 10 is still under the control of the application processor and the secure element has not yet been solicited. It is therefore necessary to ensure that the user is fully informed that the information displayed in region 10 really comes from the secure element. To overcome this problem, two cases are distinguished:
1) Region 10 is of a fixed height h0 and occupies a fixed location on the display, across the entire width of the display. For example, region 10 occupies the “N” last lines of the display corresponding to height h0, as shown in FIG. 9A.
2) Region 10 is of a variable height h and can possibly be located in a variable location over all or part of the height of the display, the height h of region 10 and its location being defined by the configuration data SDT. In an example shown in FIG. 9B, region 10 has a height h1 and occupies the entire lower part of the display. In another example shown in FIG. 9C, region 10 has a height h2 greater than h1 and extends substantially over two-thirds of the lower half of the display without occupying the lower part of it.

In an embodiment corresponding to the first case, the secure element is configured to activate the light indicator LD when it sets the signal PIP to the active value. In this case, and as schematized in FIG. 9A, the user is fully informed by means of the light indicator LD, which is under the exclusive control of the secure element via the pin GPIO2, that the secure element controls region 10. As an additional means of informing the user, the location of region 10 may be indicated by means of a visual marker such as a color bar VM provided on the terminal casing, next to the display, over the entire height of region 10.

In an embodiment corresponding to the second case, a row LR of light indicators Li, each formed by an LED, is provided along the display, and extends over all or part of its height. The row of light indicators is driven by input/output pins GPIOi of the secure element, and is provided to indicate the precise location of region 10, each light indicator being individually controlled by the secure element. Thus, in the example of FIG. 9B, the secure element lights up the first 7 diodes L1 to L7, and in the example of FIG. 9C, the secure element lights up diodes L6 to L15. The user is therefore fully informed that the secure element controls region 10, and is also informed of the location of this region 10. In such an embodiment, the row LR of light indicators replaces the single light indicator LD previously described, which is no longer necessary.

In another embodiment, corresponding to the second case and illustrated in FIGS. 9D, 9E, two measures are provided to delimit region 10 and inform the user that the secure element controls this region:
i) One or more lines of the display, for example the last line or a few of the last lines, form a reference region 101 that is under the permanent control of the secure element, thanks to a corresponding configuration of the dynamic multiplexer DYMUX. Such a configuration, independent of the value of the signal PIP, prevents the application processor from displaying information in this region.
ii) When the secure element switches to secure mode and takes control of region 10, it frames it with a border 102 having a determined appearance that is identical to that of region 101. If region 10 is not in the immediate extension of region 101, the secure element can also and optionally display a link region 103 connecting border 102 to region 101, whose appearance is identical to that of region 101.

The aforementioned appearance of the reference region 101 is preferably variable and random. It may be of a determined color or a determined color combination, a determined pattern comprising a color combination or a gray gradient, a determined visual texture, excerpts from photographs, etc. Given that a malicious program cannot access the information sent by the secure element to the display controller DMCU, which determines the appearance of the reference region 101, such a malicious program will be unable, if it wants to simulate region 10, to frame it with a border 102 having the same appearance as the reference region 101.

The implementation of the dynamic multiplexer DYMUX may be achieved in various ways within the reach of those skilled in the art. Some will be described in the following in relation to FIGS. 10 to 15, which show embodiments DYMUX1, DYMUX2, DYMUX3, DYMUX4, DYMUX5, and DYMUX6 of this multiplexer.

The dynamic multiplexer DYMUX1 of FIG. 10 includes a hardware multiplexer MUX1, a synchronization circuit SYNCT1, and the configuration register SREG. In the embodiment considered here, the buses DISPB1, DISPB2 each convey data packets forming pixels, respectively IPAQ1, IPAQ2, as well as a clock signal, respectively CLK1, CLK2, and a synchronization signal, respectively TE1, TE2 (“Tearing Effect Signal”), conventionally used as a means to prevent image tearing. Depending on the value of the signal SEL, the image data IPAQ provided at the output of multiplexer MUX1 are the data IPAQ1 or the data IPAQ2, the clock signal CLK is the signal CLK1 or the signal CLK2, and the end-of-frame signal TE is the signal TE1 or the signal TE2. This last signal is issued, for example, every 20 ms for an image refreshed at a frequency of 50 Hz.

The SYNCT1 circuit includes a line counter LCPT that counts the lines displayed on the bus DISPB and is configured to determine, from the configuration data SDT present in the register SREG, the times T1 when the packets present on the bus DISPB1 are provided on the bus DISPB, and the times T2 when the packets present on the bus DISPB2 are provided on the bus DISPB instead of the packets present on the bus DISPB1, i.e., the times when the signal SEL changes value.

To allow precise control of times T1 and T2, the synchronization circuit SYNCT1 takes from the buses DISPB1, DISPB2, and DISPB synchronization information SI1, SI2, SI. The synchronization information SI1, SI2, SI includes, for example, the clock signals CLK1, CLK2, CLK and end-of-frame signals TE1, TE2, TE. The synchronization circuit SYNCT1 also includes pixel counters PCPT1, PCPT2, PCPT associated respectively with the buses DISPB1, DISPB2, DISPB, which each provide an end-of-line signal, respectively LEP1, LEP2, LEP (“Line End Pulse”). Each counter is reset after detecting an end of line, then counts a number of pixels again until reaching the number of pixels of a line, following which it issues the end-of-line signal again and resets to zero, and so on. The operation of these counters is within the reach of those skilled in the art and relies on known principles of video signal analysis. Indeed, the length of a line is known by analyzing the content of all the data packets it contains. An end-of-line signal may also be detected via an analog measurement system, because an end of line on a MIPI signal corresponds to a transition of the voltage of an electrical signal from a value of around 200 mV to a value of around 2 V. A Schmitt trigger may therefore also be used to determine the end of a line.

The synchronization circuit SYNCT1 sends to the display controller DMCU synchronization data SYNCDT1 relative to the bus DISPB1 and the bus DISPB, and sends to the application processor APROC synchronization data SYNCDT2 relating to the bus DISPB2 and the bus DISPB. The synchronization data SYNCDT1 include, for example, the end-of-frame signals TE1, TE, the end-of-line signals LEP1, LEP, and the clock signals CLK1, CLK. The synchronization data SYNCDT2 include, for example, the end-of-frame signals TE2, TE, the end-of-line signals LEP2, LEP, and the clock signals CLK2, CLK. Thus, the application processor APROC receives information on the state of the bus DISPB2 controlled by the display controller DMCU and reciprocally the display controller DMCU receives information on the state of the bus DISPB1 controlled by the application processor APROC. The application processor and the display controller can thus implement a common synchronization strategy allowing the circuit SYNCT1 to apply the signal SEL to the hardware multiplexer MUX1 without causing the appearance of artifacts or tearing of the displayed image. However, it is not essential in practice to provide for an immediate switching between the two buses DISPB1, DISPB2. Indeed, it is possible with most screens to have a certain latency in the supply of line data. The multiplexer switching may therefore have such a “latency” between the stopping of the flow conveyed by the bus DISPB1 and the application of the flow conveyed by the bus DISPB2, or vice versa, without however this latency being too important at the risk of altering the display frequency.

The embodiment of the multiplexer DYMUX1 that has just been described is generic and can be simplified by using only a part of the aforementioned synchronization signals. As an example, the dynamic multiplexer DYMUX2 of FIG. 11 includes a hardware multiplexer MUX2 of the same type as the multiplexer MUX1 and a simplified synchronization circuit SYNCT2. The latter includes only the pixel counter PCPT providing the end-of-line signal LEP, and extracts the end-of-frame signal TE from the data circulating on the output bus DISPB. The end-of-line signal LEP and the end-of-frame signal TE are sent to the display controller DMCU and to the application processor APROC so that they recalibrate to the same reference at each new line and at each new image. The display controller DMCU also receives the clock signal CLK1 from the bus DISPB1 and itself ensures the provision of the signal SEL to the hardware multiplexer MUX2. For this purpose, the display controller DMCU is equipped with the configuration register SREG, the line counter LCPT, and receives the signal PIP. The signal PIP allows it to determine, from the configuration data SDT present in the register SREG, the times T1 when the packets present on the bus DISPB1 are to be provided on the bus DISPB, and the times T2 when the packets present on the bus DISPB2 are to be provided on the bus DISPB instead of the packets present on the bus DISPB1.

In this embodiment, the display controller DMCU automatically adapts to the clock signal CLK1 of the bus DISPB1 controlled by the application processor, and can replace image data provided by the latter with image data provided by the display controller DMCU of the secure element, without causing the appearance of artifacts or a tearing of the displayed image.

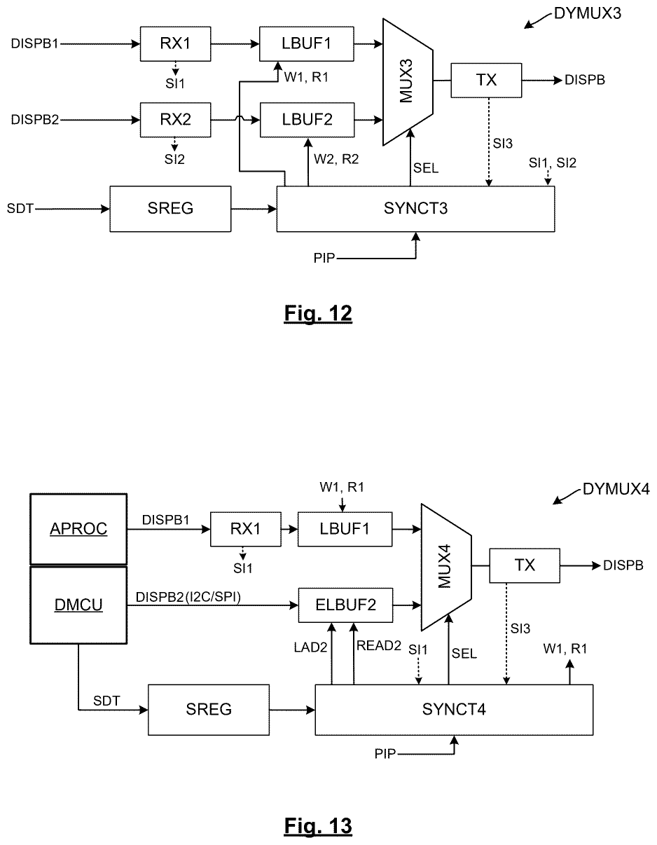

The dynamic multiplexer DYMUX3 of FIG. 12 includes a hardware multiplexer MUX3, a synchronization circuit SYNCT3, the register SREG, a reception circuit RX1 connected to the bus DISPB1, a reception circuit RX2 connected to the bus DISPB2, a line buffer LBUF1 whose input is connected to the output of the circuit RX1 and whose output is connected to a first input of the multiplexer MUX3, a line buffer LBUF2 whose input is connected to the output of the circuit RX2 and whose output is connected to a second input of the multiplexer MUX3, and a transmission circuit TX whose input is connected to the output of the multiplexer MUX3 and whose output is connected to the bus DISPB. Unlike the multiplexers MUX1, MUX2 of FIGS. 10, 11, the multiplexer MUX3 is a multiplexer of raw digital data and not a multiplexer of image data received encapsulated in a frame coded according to a determined protocol. Indeed, the raw data carried on the bus DISPB1 are decoded—or more precisely de-encapsulated—by the reception circuit RX1, then loaded into the line buffer LBUF1 to then be applied to the first input of the multiplexer MUX3. Similarly, the raw data carried on the bus DISPB2 are de-encapsulated by the reception circuit RX2 then loaded into the line buffer LBUF2 to then be applied to the second input of the multiplexer MUX3. For this purpose, the SYNCT3 circuit applies to the buffers LBUF1, LBUF2 write signals W1, W2 and read signals R1, R2.

The reception circuits RX1, RX2, provide to the circuit SYNCT3 synchronization information SI1, SI2 allowing it to count the number of lines of an image that have been displayed and to determine the times T1 when the content of the buffer LBUF1 is to be applied to the input of the transmission circuit TX as well as the times T2 when the content of the buffer LBUF2 is to be applied to the input of the transmission circuit TX. The transmission circuit TX reconstitutes on the bus DISPB, from the raw data provided by the buffers LBUF1, LBUF2, a video frame coded according to the desired protocol, which may be the same as that of the buses DISPB1, DISPB2 or another protocol. The circuit TX also communicates to the circuit SYNCT3 synchronization information SI3 allowing it to perfect the control of the multiplexer MUX3.

The dynamic multiplexer DYMUX4 of FIG. 13 includes a hardware multiplexer MUX4 identical or of the same type as the multiplexer MUX3, and a synchronization circuit SYNCT4. It differs mainly from the multiplexer DYMUX3 in that the reception circuit RX2 is removed, the line buffer LBUF2 being replaced by an extended line buffer ELBUF2 that can receive raw data corresponding to several lines of the image to be embedded. The display controller DMCU directly accesses the extended line buffer ELBUF2 without going through the provision of a video signal. For this purpose, the bus DISPB2, instead of being a bus carrying video frames according to the MIPI-DSI protocol or other video protocol, can simply be an I2C or SPI bus. When the buffer ELBUF2 has been filled by the display controller DMCU, the synchronization circuit SYNCT4 performs several buffer reading cycles for the provision of its content to the multiplexer MUX4, by successively applying to the buffer line addresses LAD2 followed by a read signal READ2. In order to avoid the appearance of visual artifacts due to the updating of data in the extended line buffer ELBUF2, a double buffer system may be provided, a first buffer being used while the second buffer is being filled, the second buffer, once full, then being used while the first buffer is being filled, and so on.

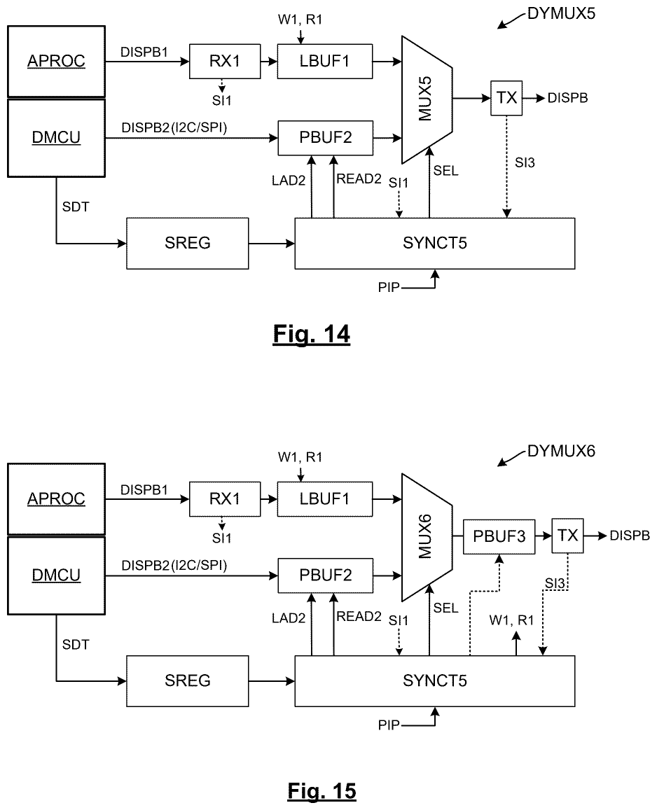

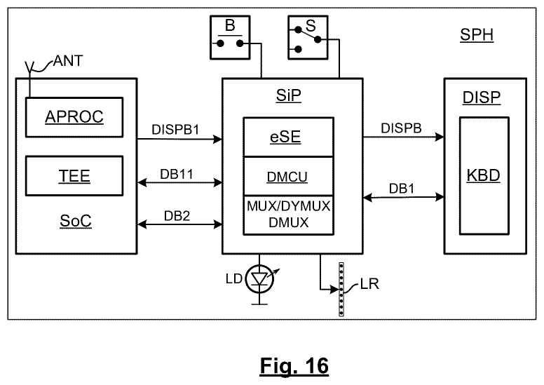

The dynamic multiplexer DYMUX5 of FIG. 14 includes a hardware multiplexer MUX5 identical or of the same type as the multiplexers MUX3, MUX4, and a synchronization circuit SYNCT5. It differs mainly from the multiplexer DYMUX4 in that the extended line buffer ELBUF2 is replaced by a page buffer PBUF2 in which the display controller DMCU has previously loaded all the lines of region 10 (FIG. 8).

In an alternative embodiment shown in FIG. 15 also applicable to the embodiments of FIGS. 12 and 13, the dynamic multiplexer DYMUX6 includes a multiplexer MUX6 whose output, instead of being applied directly to the transmission circuit TX, is applied to a page buffer PBUF3 which is previously loaded with all the lines of a page before its content is applied to the circuit TX for the generation of the video signal on the bus DISPB. This previously stored integral page may include lines provided by the application processor and lines provided by the display controller DMCU, occupying region 10. In this case, the multiplexer MUX6 is no longer of the same type as the multiplexers previously described, and although still designated here by the term “multiplexer” because it provides the same technical effect, it rather forms a buffer-to-buffer copy system with two input channels and one output channel. Although the embodiments of the dynamic multiplexer that have just been described ensure an embedding of the image data provided by the secure element with an embedding granularity, or embedding pitch, at the scale of a line of the image data provided by the application processor, those skilled in the art may modify this embedding pitch according to the target objectives in terms of ergonomics and user experience. In some embodiments, the embedding pitch may, in particular, be at the scale of the pixel of the image data provided by the application processor. In the embodiment of FIG. 14 for example, the multiplexer MUX5 may be configured to select the image data pixel by pixel from the buffers LBUF1 and PBUF2, and thus fill the output buffer PBUF3 pixel by pixel.

FIG. 16 illustrates a layout of components of a mobile terminal (smartphone) according to one of FIGS. 4 to 8, 10 to 14. The application processor APROC and its eventual enclave TEE may be part of a system-on-chip SoC (“System-on-Chip”). The application processor APROC or the SoC that receives it includes pins soldered to respective tracks of a printed circuit board or other interconnection support receiving a number of other components. Respective groups of pins are associated with the different communication links between the components, particularly the buses DISPB, DISPB1, DB1, DB2, DB11 previously mentioned.

The display DISP and the touchpad KBD are generally external and parallel to the printed circuit board. Their control buses are then connected to the printed circuit board by connectors soldered to tracks of the printed circuit board.

In an embodiment, the elements described above, allowing the implementation of an embedded hardware wallet, particularly the elements eSE, DMCU, MUX or DYMUX and DMUX, as well as the buses that connect them and possibly the connectors of all or part of the elements B, S, LD, LR may be integrated into a system-in-package SiP designed to be mounted on a printed circuit board. Alternatively, these elements may be integrated in another SoC.

Thus, to integrate a hardware wallet into a mobile terminal, a space is arranged on the printed circuit board to solder the system-in-package SiP, the tracks of the different buses used are re-routed by interrupting them so that they pass through the SiP, and tracks are provided to establish the secure connection between the processor APROC and the secure element eSE.

The different discrete physical elements managed by the circuits of the SiP (button B, switch S, light indicator LD) may be fixed to the casing of the terminal and connected to connectors of the SiP, or to connectors of the printed circuit board, themselves connected by tracks to dedicated pins of the SiP.

With this configuration, a conventional mobile terminal may be transformed into a mobile terminal including an embedded hardware wallet by simply adding a SiP on a printed circuit board carrying the components of the conventional terminal. Although the design of an adapted printed circuit board represents a certain cost of development and production, this cost remains negligible because there is no adaptation to be made at the level of the hardware platform of the conventional terminal.

The preceding description has been written essentially in the context of smartphones embedding a hardware wallet for signing transactions on the blockchain (“blockchain smartphones”). It will be apparent to those skilled in the art that the means and methods that have just been described to ensure the control of the display by the secure element during the signing of a transaction apply to any secure operation requiring this same control. The means and methods described also apply to any type of terminal connected to the Internet or a local network storing secrets used for various purposes involving cryptographic calculations, such as the signing of transactions in general and authentication, including “zero knowledge” authentication. In other types of connected terminals, the human-machine interface may be a display associated with a physical keyboard, or a joystick.

1. A connected terminal configured to execute a secure operation, the terminal comprising:
an application processor configured to initiate the secure operation,
a secure element for executing the secure operation,
a display accessible via a wired bus and configured to receive, from the application processor, image data to be displayed to a user,
means controlled by the secure element and configured to, at the request of the secure element and at least during the execution of the secure operation, alternately apply to the wired bus of the display image data provided by the application processor and image data provided by the secure element, such that the image data provided by the secure element replace image data provided by the application processor and form a secure image embedded in a non-secure image provided by the application processor, the secure image extending in at least one determined region of the display, and
means controlled by the secure element for indicating to the user a location and extent of the region in which the embedded secure image is displayed.

2. The terminal according to claim 1, comprising at least one light indicator activated by the secure element when the secure element embeds a secure image in a non-secure image provided by the application processor.

3. The terminal according to claim 1, wherein the means for indicating the location and extent of the region in which the embedded secure image is displayed comprise a row of light indicators controlled by the secure element and arranged along an edge of the display.

4. The terminal according to claim 1, wherein the means for indicating the location and extent of the region in which the embedded secure image is displayed comprise:
a region of the display that is permanently under the control of the secure element, and that displays a determined appearance, and
a border of the region in which the embedded secure image is displayed, which has the same appearance as the region of the display that is permanently under the control of the secure element.

5. The terminal according to claim 1, wherein the means configured to alternately apply to the wired bus of the display image data provided by the application processor and image data provided by the secure element, comprise:
a multiplexer receiving on a first input the image data provided by the application processor and on a second input the image data provided by the secure element, and
a control circuit of the multiplexer, configured to control the multiplexer according to a configuration data provided by the secure element.

6. The terminal according to claim 5, wherein the control circuit is configured to control the multiplexer with a determined embedding granularity of the image data provided by the secure element, said embedding granularity being at a scale of a line or at a scale of a pixel of the image data provided by the application processor.

7. The terminal according to claim 1, wherein the secure element is configured to, before performing the secure operation, embed in a non-secure image provided by the application processor a secure image comprising information about the secure operation.

8. The terminal according to claim 1, further comprising an input device providing touch data on a data bus, and a demultiplexer controlled by the secure element and configured to connect the data bus of the input device to a bus of the application processor or to a bus of the secure element.

9. The terminal according to claim 8, wherein the secure element is configured to connect to the input device during a display of information about the secure operation in the secure image.

10. The terminal according to claim 1, comprising a physical button actionable by the user and monitored by the secure element, wherein the secure element is configured to bypass the secure operation in the absence of a user action on the physical button.

11. The terminal according to claim 1, wherein the secure element and the means for alternately applying to the wired bus of the display image data provided by the application processor and image data provided by the secure element, are integrated wholly or partially in a system-in-package or in a system-on-chip mounted on an interconnection support of the terminal.

12. The terminal according to claim 1, wherein the secure operation comprises data being signed using a secret key.

13. The terminal according to claim 1, devoid of any display controller between the display and the means controlled by the secure element, the image data alternately applied to the wired bus of the display by the means controlled by the secure element being in a format compatible with the display and not requiring, to be displayed, to be converted into another format.

14. A method for conducting a secure operation using a connected terminal, in particular signing of data using a secret key, the terminal comprising:
an application processor configured to initiate the secure operation,
a secure element holding a private key and configured to execute the secure operation, and
a display accessible via a wired bus and configured to receive, from the application processor, non-secure images related to a progress of the secure operation,
the method comprising:
a step of providing means controlled by the secure element and configured to, at the request of the secure element, alternately apply to the wired bus of the display image data provided by the application processor and image data provided by the secure element, such that the image data provided by the secure element replace image data provided by the application processor and form said secure image embedded in the non-secure image provided by the application processor,
a step of embedding, in at least one non-secure image provided by the application processor and presented on the display, a secure image provided by the secure element and inaccessible to the application processor, the secure image comprising information about the secure operation and extending in at least one determined region of the display, the embedding step being under the control of the secure element and unable to be prevented or corrupted by the application processor, and
a step under the control of the secure element, of indicating to a user a location and extent of the region in which the embedded secure image is displayed, said step of indicating implementing means controlled by the secure element.

15. The method according to claim 14, wherein image data in a format compatible with the display and not requiring, to be displayed, to be converted into another format are alternately applied to the wired bus of the display, and no display controller is provided between the display and the means controlled by the secure element.

16. The method according to claim 14, comprising providing in the terminal at least one light indicator and comprising a step of activating the light indicator by the secure element when the secure element embeds a secure image in a non-secure image provided by the application processor.

17. The method according to claim 14, wherein the location and extent of the region in which the embedded secure image is displayed are indicated by means of a row of light indicators controlled by the secure element and arranged along an edge of the display.

18. The method according to claim 14, wherein the location and extent of the region in which the embedded secure image is displayed are indicated by means of:
a region of the display that is permanently under the control of the secure element and that has a determined appearance, and
a border of the region in which the embedded secure image is displayed, which has the same appearance as the region of the display permanently under the control of the secure element.

19. The method according to claim 14, wherein the terminal comprises an input device providing touch data on a data bus, and comprising the step of connecting the input device to the secure element during the display of information about the secure operation in the embedded secure image.

20. The method according to claim 14, wherein the terminal comprises a physical button actionable by the user and monitored by the secure element, and comprising a step of configuring the secure element such that it bypasses execution of the secure operation in the absence of a user action on the physical button.

21-23. (canceled)
